(19) United States
(12) Patent Application Publication
(10) Pub. No.: US 2026/0359197 A1
(43) Pub. Date: Nov. 12, 2026

(54) DEBUGGING AGENTS USING TRAJECTORIES

(71) Applicant: NEC Laboratories America, Inc., Princeton, NJ (US)

(72) Inventors: Wei Cheng, Princeton Junction, NJ (US); Haifeng Chen, West Windsor, NJ (US)

(21) Appl. No.: 19/673,043

(22) Filed: May 11, 2026

Related U.S. Application Data
(60) Provisional application No. 63/804,098, filed on May 12, 2025.

(51) Int. Cl. G06F 11/362

(52) U.S. Cl. CPC G06F 11/3636

(57) ABSTRACT

Systems and methods for debugging artificial intelligence (AI) agents. The method including receiving a first agent trajectory from an AI agent, the first agent trajectory containing at least one failed task, identifying an error type of the first agent trajectory by referencing historical trajectories stored in a database, retrieving an error type of the first agent trajectory from a database, wherein the database stores agent types and trajectories with corresponding error type labels and a natural language explanation, retrieving a second agent trajectory based on similarity from the database, prompting an LLM to generate an explanation of the second agent trajectory using the corresponding error type and natural language explanation, the explanation of the second agent trajectory including the error type of the first agent trajectory and a justification, and prompting the AI agent to execute the failed task with an instruction to refine accuracy based on the explanation.

### RELATED APPLICATION INFORMATION

This application claims priority to U.S. Provisional Patent Application No. 63/804,098, filed on May 12, 2025, incorporated herein by reference in its entirety.

### BACKGROUND

### Technical Field

The present invention relates to debugging artificial intelligence (AI) agents and more particularly debugging AI agents using trajectories.

### Description of the Related Art

Large language model (LLM) agents frequently rely on external tools for real-time information retrieval, math computation, and data processing in agent scenarios. By integrating various external tools and memory blocks, LLM agents have achieved remarkable progress across a wide range of applications. Despite these advancements, these LLM agents continue to encounter substantial challenges. The increasing complexity of agent systems gives rise to unique failure modes that are not typically encountered in standard LLM use cases, such as tool misusage and infinite loops. Furthermore, LLM agents may produce many compounding errors due to real-world planning and its planning trajectory is also unfaithful. Thus, there is a need to be able to debug these agents.

### SUMMARY

According to an aspect of the present invention, a method is provided for debugging artificial intelligence (AI) agents and improving AI agent decision making. The method including receiving a first agent trajectory from an AI agent, the first agent trajectory containing at least one failed task, identifying an error type of the first agent trajectory by referencing historical trajectories stored in a database, retrieving an error type of the first agent trajectory from a database, wherein the database stores agent types and trajectories with corresponding error type labels and a natural language explanation, retrieving a second agent trajectory based on similarity from the database, prompting an LLM to generate an explanation of the second agent trajectory using the corresponding error type and natural language explanation, the explanation of the second agent trajectory including the error type of the first agent trajectory and a justification, and prompting the AI agent to execute the failed task with an instruction to refine accuracy based on the explanation.

According to another aspect of the present invention, a system is provided for debugging AI agents and improving AI agent decision-making. The system can include a memory device, and one or more processor devices operatively coupled with the memory device to perform operations, the operations including receive a first agent trajectory from an AI agent, the first agent trajectory containing at least one failed task, identify an error type of the first agent trajectory by referencing historical trajectories stored in a database, retrieve an error type of the first agent trajectory from a database, wherein the database stores agent types and trajectories with corresponding error type labels and a natural language explanation, retrieving a second agent trajectory based on similarity from the database, prompt an LLM to generate an explanation of the second agent trajectory using the corresponding error type and natural language explanation, the explanation of the second agent trajectory including the error type of the first agent trajectory and a justification; and prompt the AI agent to execute the failed task with an instruction to refine accuracy based on the explanation.

According to another aspect of the present invention, a non-transitory computer program product is provided for debugging AI agents and improving AI agent decision-making. The non-transitory computer program product including a computer-readable storage medium including a program code, wherein the program code when executed on a computer causes the computer to perform receive a first agent trajectory from an AI agent, the first agent trajectory containing at least one failed task, identify an error type of the first agent trajectory by referencing historical trajectories stored in a database, retrieve an error type of the first agent trajectory from a database, wherein the database stores agent types and trajectories with corresponding error type labels and a natural language explanation, retrieve a second agent trajectory based on similarity from the database, prompt an LLM to generate an explanation of the second agent trajectory using the corresponding error type and natural language explanation, the explanation of the second agent trajectory including the error type of the first agent trajectory and a justification, and prompt the AI agent to execute the failed task with an instruction to refine accuracy based on the explanation.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for debugging AI agents using trajectories in accordance with an embodiment of the present invention;

FIG. 2 is an illustrative example of a practical application for debugging AI agents using trajectories, in accordance with an embodiment of the present invention;

FIG. 3 is a block/flow diagram illustrating an agent debugger platform, in accordance with an embodiment of the present invention;

FIG. 4 is an illustrative example of one use case, in accordance with an embodiment of the present invention;

FIG. 5 is a block/flow diagram depicting one use case, in accordance with an embodiment of the present invention;

FIG. 6 is an illustrative example of one use case, in accordance with an embodiment of the present invention;

FIG. 7 is a block/flow diagram depicting a system/method for debugging AI agents using trajectories, in accordance with an embodiment of the present invention;

FIG. 8 is a block diagram depicting a database for debugging AI agents using trajectories, in accordance with an embodiment of the present invention;

FIG. 9 is a block diagram depicting a dataset for debugging AI agents using trajectories, in accordance with an embodiment of the present invention;

FIG. 10 is a flow diagram illustrating a system/method for debugging AI agents using trajectories, in accordance with an embodiment of the present invention; and

FIG. 11 is a block/flow diagram illustrating a system for debugging AI agents using trajectories, in accordance with an embodiment of the present invention.

### DETAILED DESCRIPTION OF PREFERRED EMBODIMENTS

In accordance with embodiments of the present invention, systems and methods are provided for debugging artificial intelligence (AI) agents using trajectories.

Embodiments of the present invention can receive trajectories of an AI agent operating in agent environment and have the agent refine accuracy if there is an error. This can improve the overall decision-making of the AI agent. A trajectory can be described as the complete sequence of interactions between an agent and its environment during the execution of a given task. Formally, a trajectory is composed of an ordered series of steps, where each step includes the agent's observation, its corresponding action, and optionally, the system's feedback. A trajectory encapsulates an execution process from task initiation to termination, either successful completion or failure. Trajectories can be employed for subsets of an entire process as well. An action in the trajectory serves as the basic unit for analyzing agent behavior, identifying errors, and diagnosing failure cases.

Embodiments of the present invention receive the agent trajectory and retrieves the error type and historical trajectories from a database. The database can be organized by domains. Furthermore, the database can store natural language explanations for the historical trajectories. Embodiments of the present invention then prompt a large language model (LLM) to analyze the error while including the error type, a historically similar trajectory, and corresponding natural language explanation.

The natural language explanation acts as guidance and further lowers error rates. By including the error type, the accuracy of error detection increases as the system/method has less to search for. After prompting the LLM to analyze the error, the output of the LLM is used by the AI agent to refine accuracy and prevent future errors of the same type.

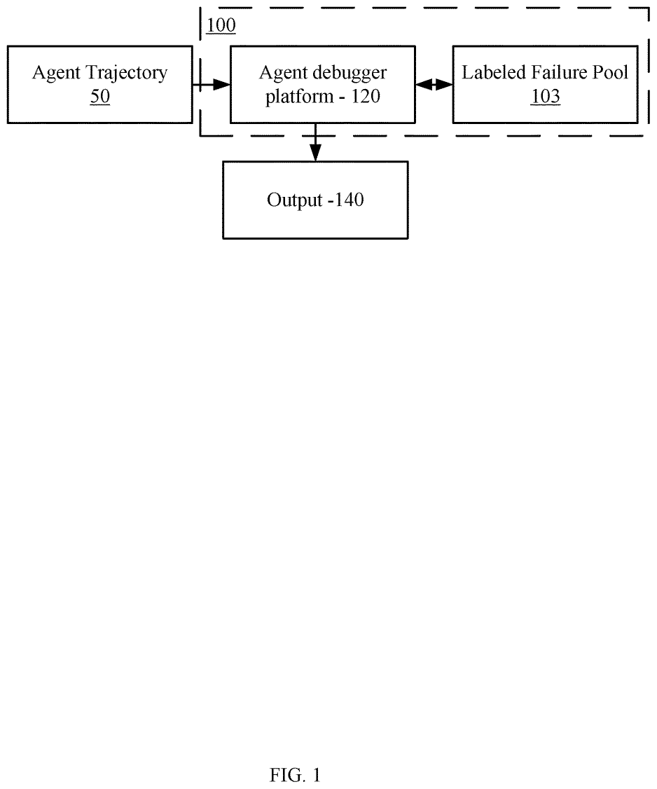

Referring now in detail to the figures in which like numerals represent the same or similar elements and initially to FIG. 1, a high-level system/method 100 for debugging artificial intelligence (AI) agents is illustratively depicted in accordance with one embodiment of the present invention. The system/method 100 may include an agent debugger platform 120 and a labeled failure pool 103. The agent debugger platform 120 receives agent trajectory 50 and accesses labeled failure pool 103 to find a similar trajectory. Then based on the similar trajectory, the agent debugger platform 120 can produce an output 140. The output 140 can be used to refine accuracy in the AI agent that sent the agent trajectory to begin with.

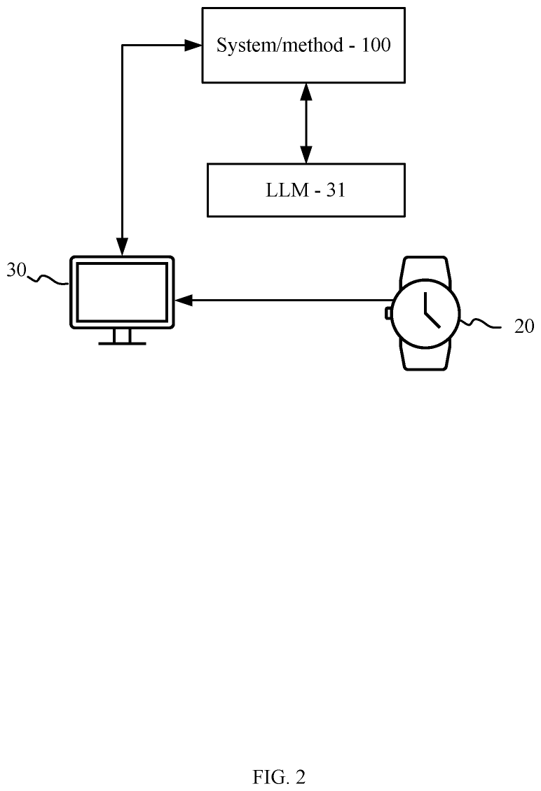

FIG. 2 depicts a practical application of an embodiment of the present invention in healthcare. The AI agent 30 can generate personalized health advice (e.g., diet, exercise) based on real-time data from wearable devices 20. The problem is that the agent misinterprets sensor noise (e.g., a heart rate spike from a poorly fitted device) as a sign of a serious cardiac event, leading to incorrect actions. This causes undue anxiety for the user and prompts unnecessary medical consultations, ultimately eroding trust.

In this case, the AI agent's 30 trajectory includes healthcare data which can include sensor data logs. The trajectory can further include thought process, and generated alert. The trajectory is sent to the system/method 100 for debugging AI agents. The system/method 100 can analyze the error in the trajectory by using rule matchings and by prompting a large language model (LLM) 31. For rule matching, the system/method 100 matches the trajectory against rules stored in database 130. In this practical application, the rule can be healthcare-specific rules such as “A single data spike without continuity is likely noise.” The system/method 100 then prompts LLM 31 to classify the trajectory. In this case, the LLM 31 classifies the error as a “LogicGap” error by referencing similar historical failure cases. The system/method 100 then supports the decision by generating a natural language report. The report can include a cause and a recommendation. For example, the natural language report can recite “Cause: Incorrect inference from ambiguous data” and “Recommendation: Contact carrier to confirm the reason.”

A benefit of the system/method 100 in healthcare is that the system/method 100 can prevent false alarms which reduces unnecessary user anxiety and healthcare costs. Another benefit of the system/method 100 is that the system/method 100 enhances trust and safety in AI agents. Another benefit of the system/method 100 is that the system/method 100 allows for the continuous improvement of the AI agent.

Another practical application of an embodiment of the present invention is in supply chain management. The focus is on automated detection of exceptions (exceptions (e.g., shipping delays, customs issues) and proposal of countermeasures by an AI agent. In supply chain management, one problem is that the AI agent misinterprets the cause of an exception (e.g., misjudging the reason for a “customs hold”), leading to incorrect actions. This results in delivery delays and increased costs due to lengthy manual investigations.

In this practical application, the trajectory input includes API calls, thought process, and action selection and is fed into system/method 100. The analysis of the error can include rule matching. The trajectory can be matched against logistics rules such as “No corrective action without root cause identification.” The LLM 31 can be prompted to analyze the error and come to the conclusion that the error is classified as a “Fact Misunderstanding” error by referencing similar failure trajectories.

Then the LLM 31 is prompted to generate a natural language report including a cause and recommendation. For example, the language report can recite “Cause: Incorrect inference from ambiguous data” and “Recommendation: Contact carrier to confirm the reason.”

A benefit of this practical application is rapid root cause analysis which reduces operator investigation time. Another benefit is accurate initial responses. Another benefit is continuous agent improvement. These applications are not limiting and others are contemplated.

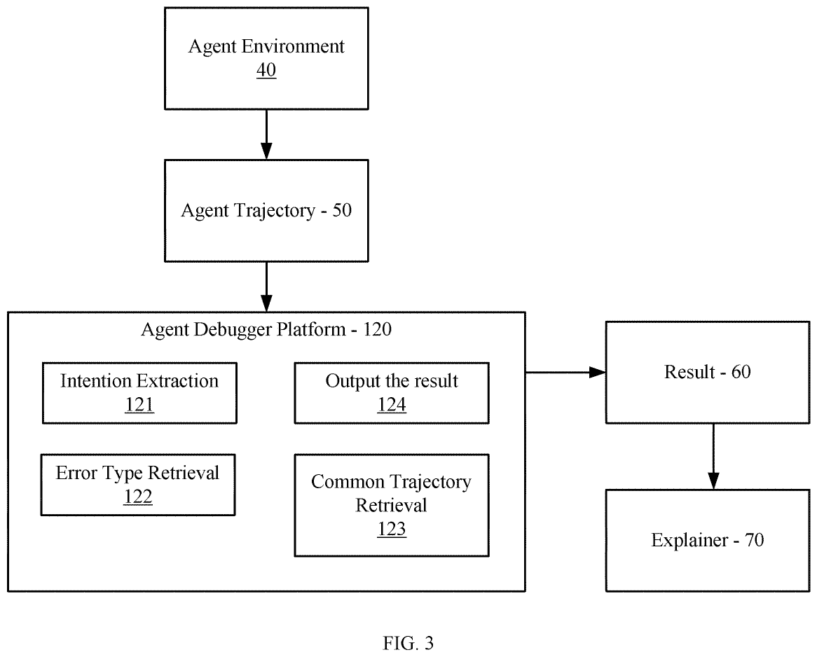

Referring to FIG. 3, the agent debugger platform 120 can include several modules. The agent debugger platform 120 can include an intention extraction module 121. The intention extraction module 121 extracts the intention of the agent trajectory 50 from agent environment 40. The intention can be the category of an error type of the agent trajectory which can be extracted by prompting a large language model (LLM). The categories can be pre-defined domains. The agent debugger platform 120 can include an error type retrieval module 122. The error type retrieval module 122 can retrieve the error type of the agent trajectory 50. The error type retrieval module 122 can access a database of historical trajectories and find the most similar historical trajectory. The error type label attached to the most similar historical trajectory is then retrieved from the database by the error type retrieval module 122.

The debugger platform 120 can include a common trajectory retrieval module 123. The common trajectory retrieval module 123 can retrieve another trajectory that is similar to the agent trajectory 50. The common trajectory retrieval module 123 can use the error type from the error type retrieval module 122 to retrieve the other trajectory. The common trajectory retrieval module 123 can further use the category from the intention extraction module 121. The debugger platform 120 can have an output module 124. The output module 124 outputs result 60. The result 60 can include the error type from the error type retrieval module 122 and the historically similar trajectory from the common trajectory retrieval module 123. The result 60 can go to an explainer module 70. The explainer module 70 can prompt an LLM with the result 60 to obtain a natural language explanation of the error in the agent trajectory 50. For example, the natural language explanation can explain that the error is due to file path validation. Then the explanation can include “The path name is correct. You need to pay attention to the path name.”

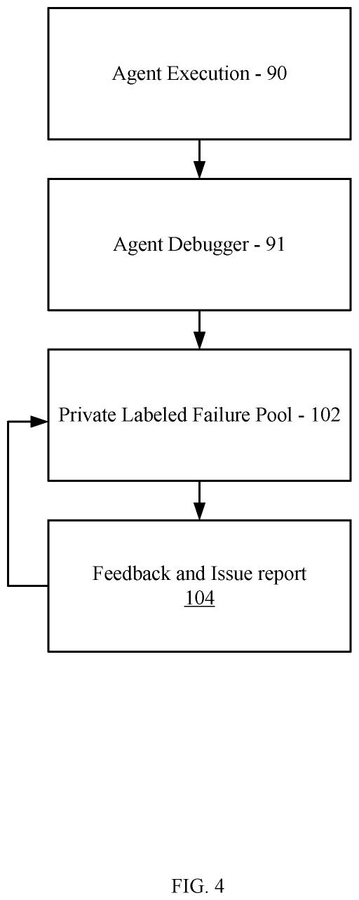

FIG. 4 depicts a use case of an embodiment of the present invention. The flowchart can begin with a block 90 for agent execution. Then an agent debugger 91 can receive a trajectory from the agent execution 91 and access the private labeled failure pool 102 to retrieve a similar trajectory. The agent debugger 91 can be a third party agent debugger. Then in block 104, a report is issued detailing the error in the agent execution 90 and feedback is given to the private labeled failure pool 102.

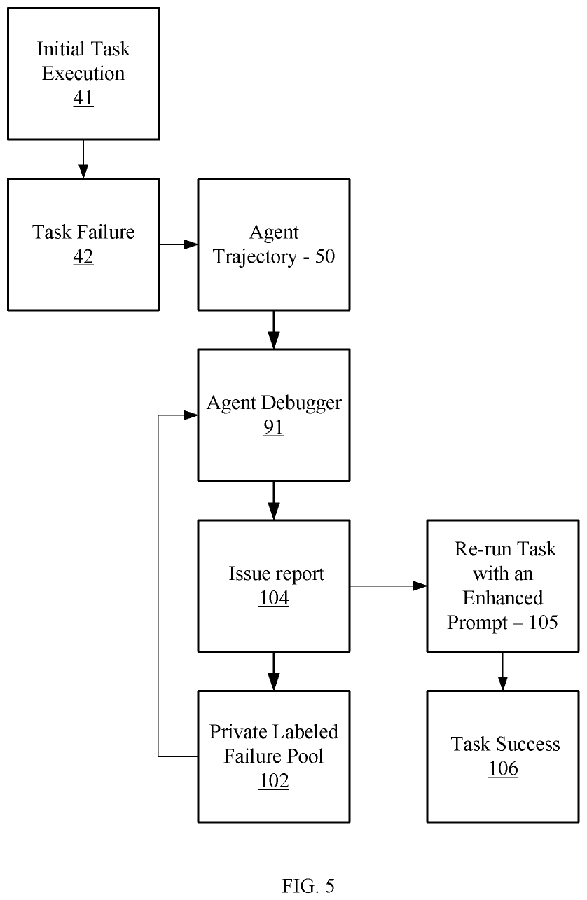

Referring to FIG. 5, the block/flow diagram begins with an initial task execution 41. The initial task execution has a task failure 42. This task failure 42 is included in the agent trajectory 50 which is then received by the agent debugger 91. The later the task failure 42 appears in the trajectory, the more relevant the task failure 42 is. The agent debugger 91 can issue a report 104 on the task failure 42 using the private labeled failure pool 102. The issued report can identify the errors in the agent trajectory 50 that caused the task failure. After the report has been issued, the agent debugger 91 can re-run the task with an enhanced prompt 105. The enhanced prompt 105 allows the agent debugger 91 to incorporate the identified error found in the issued report. This allows the agent debugger 91 to run the task successfully 106.

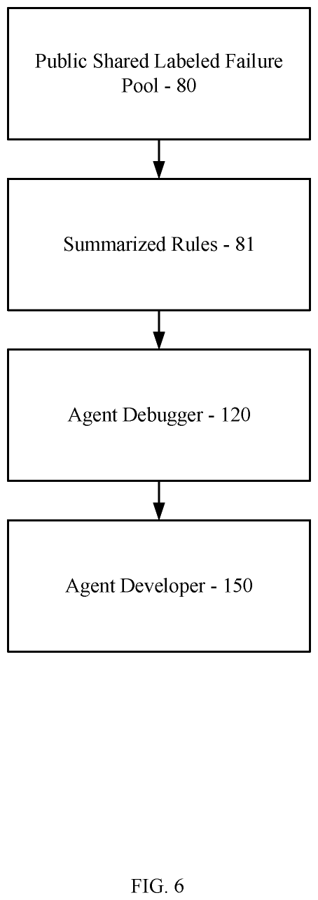

FIG. 6 is a block/flow diagram depicting a use of an embodiment of the present invention. The flowchart can begin with block 80 with a public shared labeled failure pool. Then there is a block 81 for summarized rules from the public shared labeled failure pool. Then the agent debugger 120 may use these rules to discover the bug. After the bug has been discovered, the agent developer 150 corrects the agent based on the bug.

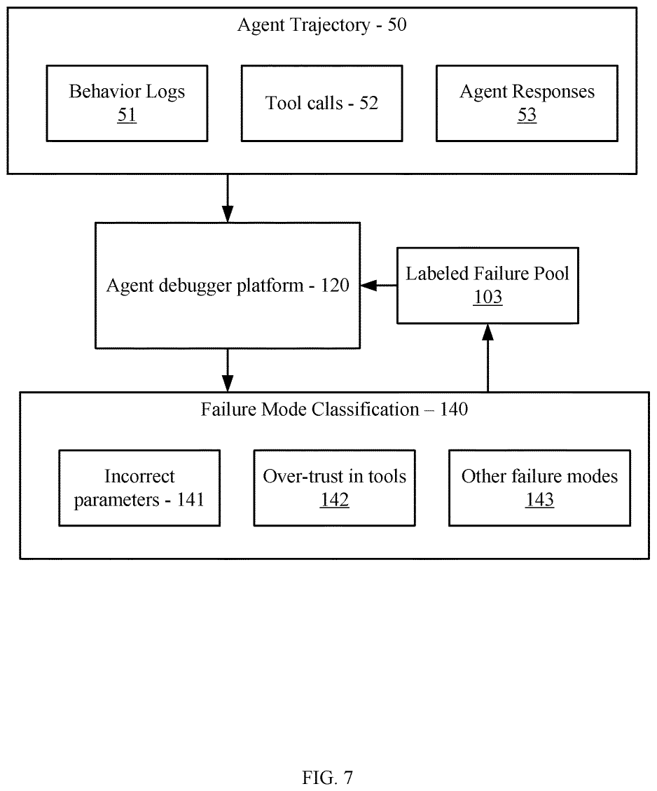

Referring to FIG. 7, the agent debugger platform 120 can receive agent trajectory 50, access the labeled failure pool 103, and output 140 the type of error in the form of failure mode classification. The agent trajectory 50 can include behavior logs 51, tool calls 52, and agent responses 53.

Once the agent debugger platform 120 receives the agent trajectory 50, the agent debugger platform 120 can use retrieval augmented generation (RAG) to search relevant curated rules that are stored in the labeled failure pool 103 and then uses RAG to search the most relevant historical agent trajectories in labeled failure pool 103.

After the agent debugger platform 120 retrieves the most relevant historical agent trajectories in the labeled failure pool 103, the agent debugger platform 120 appends the retrieved relevant rule and the top-ranked relevant failure trajectory and their diagnosis information to a running prompt and existing agent trajectory 50. The agent debugger platform 120 then prompts a large language model (LLM) to judge which predefined error category the agent trajectory 50 belongs to and generate an explanation for the failure case as the output 140. The output or failure mode classification 140 can include various failure models. The output 140 can include incorrect parameters 141 as a failure mode. The output 140 can include over-trust in tools 142 as a failure mode and other failure modes 143. The output 140 can then be added to the labeled failure pool 103 as part of the historical agent trajectories.

In one embodiment, the agent debugger platform 120 can be an extensible detection platform that provides application programming interfaces (APIs) like querying error types and retrieving trajectory-level examples.

Given an agent trajectory T, the agent debugger platform 120 first determines the agent task type by comparing T with a set of representative trajectories {T₁, T₂, . . . , Tₘ}, where each representative example Tₐ is associated with a specific agent task type a∈ [symbol] (like travel planning). This comparison can be carried out using an LLM, which receive as input the target trajectory T and the set of representative trajectory-type pairs {(Tₐ, a) [symbol] The LLM is prompted to select the agent task type a* that exhibits the highest structural and behavioral similarity to Trajectory T awaiting error diagnosis. Once the agent task type a* is identified, the agent debugger platform 120 queries the labeled failure pool 103 to retrieve a candidate set of frequently observed error types associated with that agent task type. Here, ε_{a*}={e₁, e₂, . . . , eₖ} represents the list of common error types (e.g., constraint violation, premature termination, tool misuse) that frequently occur in trajectories of agent type a*. This list serves as the candidate error space and is presented to the user or downstream modules for further analysis.

Once the agent task type a is identified, the agent debugger platform 120 retrieves the most similar trajectory example for trajectory T within the domain of type a from labeled failure pool 103. Given the set of trajectories for the identified agent type, denoted as [symbol] ₐ={T₁, T₂, . . . , Tₙ}, the agent debugger platform 120 computes similarity scores between the input trajectory T and each stored trajectory Tᵢ∈ [symbol] a, and returns:

$${T}^{*} = arg {max}_{{T}_{i} ∈ {ℳ}_{a}} sim ( T , {T}_{i} ) \qquad ( 1 )$$

The retrieved trajectory T* serves as a reference case because it provides its error type and nature language explanation that illustrates a previously observed error pattern. It helps ground the diagnostic process by providing structural guidance and concrete signals.

To analyze whether a given trajectory T contains execution errors, users can leverage the core components of the agent debugger platform 120 without requiring custom infrastructure.

Specifically, the agent debugger platform 120 receives trajectory T and can return: the predicted agent task type a*, a list of common error types ε_{a*} associated with that agent task type, a representative trajectory T* from the same domain, annotated with an error label and a natural language explanation. With this information, the agent debugger platform 120 can then prompt an LLM to determine whether trajectory T contains any of the error types in ε_{a*}, using T* and its explanation as contextual grounding. The LLM is expected to output both the predicted error type ε∈εₐ, and a justification.

ε=LLM_{judge}(T,T*,Expl(T*),ε_{a*}) (2)

In parallel with bug type ε generation, the LLM can produce a natural language explanation to help agent developers or evaluators understand the underlying reasoning behind the detected error. Formally, the explanation [symbol] is defined as:

[symbol]

=LLMₑₓₚₗₐᵢₙₑᵣ(T,E) (3)

In an embodiment of the present invention, the LLM used to return the error type is the same as the LLM used to produce the natural language explanation. In another embodiment of the present invention, the LLMs are separate.

The agent debugger platform 120 supports integration with other external rule-based or symbolic checking frameworks. Developers can apply many different frameworks to the trajectory T by leveraging the platform's APIs, such as task type classification, error type retrieval, and example trajectory fetching, as intermediate utilities.

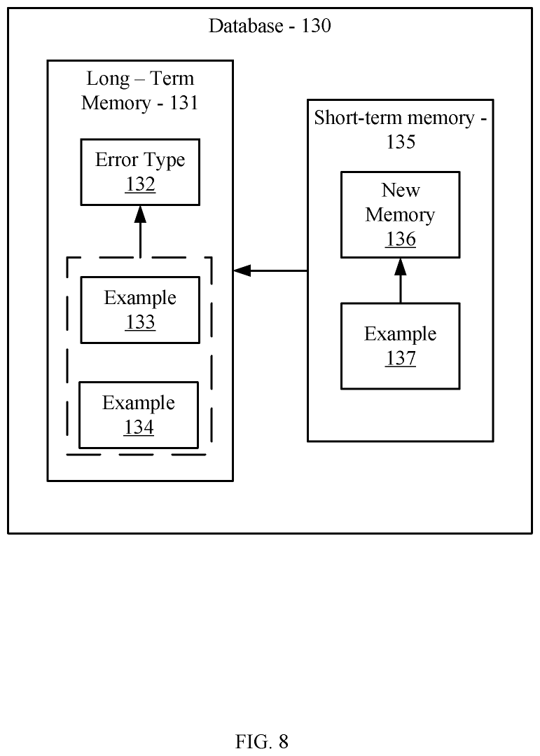

Referring now to FIG. 8, a database 130 for storing the historical agent trajectories is depicted. The database 130 can be the labeled failure pool 103 previously discussed. The database 130 can include long-term memory 131 and short-term memory 135. Long-term memory 131 can contain well-verified error types 132 and canonical examples 133, 134 curated from the full Agent Bug Bench dataset. Short-term memory 135 can store newly encountered failure trajectories or new memory 136 from ongoing agent executions or examples 137, which are not yet consolidated but may reveal emerging patterns.

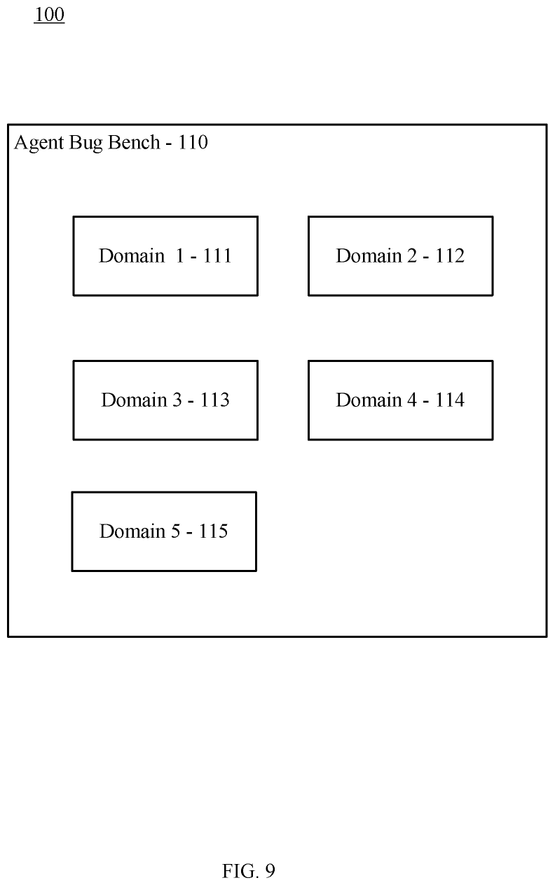

FIG. 9 depicts an agent bug bench 110. The agent bug bench 110 is for training to obtain historical trajectories. The agent bug bench 110 can be a data set. The agent bug bench 110 can have five domains to make searching easier. The five domains together can include eighteen identifiable error types and each domain can include a distribution rate of the domain's respective error types. In some embodiments, the agent bug bench 110 can have, for example, more than five domains or less than five domains. In some embodiments, the more domains there are, the more accurate the AI agent can be refined. The first domain 111 can be for operating system (OS) construction. The OS domain 111 can include a subset identifying three prevalent violations: existence, system, permission and output constraints. Each instance is annotated with the corresponding error type, and benign samples are included to ensure balanced representation.

The second domain 112 can be a travel domain. This subset can feature the longest agent trajectories. The travel domain can include the following errors: tool misusage, query misunderstanding, and data mishandling.

The third domain 113 can be a web construction domain. The Web subset is built from focusing on tasks involving multi-step browsing and media interaction. Each trajectory is segmented into user, system, and assistant turns, and annotated to identify errors while maintaining the original interaction structure. The web construction domain can include the following errors: wrong operation target, looping without progress, and premature termination.

The fourth domain 114 can be a housekeeper domain. This subset utilizes manipulation-oriented trajectories from the Agent-Bank, covering diverse household tasks. Trajectories are reformatted into observation-action pairs and inspected to annotate deviations and critical execution failures. The housekeeper domain can include the following errors: object misidentification, item not collected, missing placement, and incorrect interaction.

The fifth domain 115 can be an other error domain. This subset can include single-round Python coding tasks. Agent outputs are executed and evaluated using assertions to identify reasoning and coding errors in fundamental programming constructs. The other error domain can include the following errors: assertion failure, logic gap, value error, and type error.

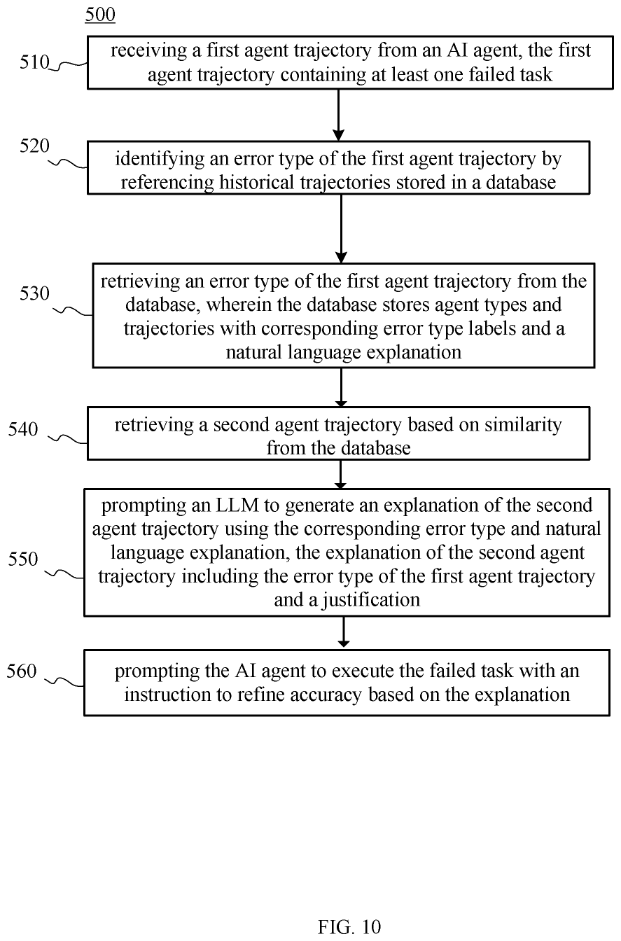

Referring now to FIG. 10, a flow diagram 500 of a high-level overview of debugging AI agents using trajectories, in accordance with an embodiment of the present invention. The flow diagram 500 can begin with block 510 for receiving a first agent trajectory from an AI agent, the first agent trajectory containing at least one failed task. The first agent trajectory can come from the AI agent interacting in the agent environment.

In block 520, an error type of the first agent trajectory is identified by referencing historical trajectories stored in a database. The error type can further be identified by matching the first agent trajectory with a rule stored in the database.

In block 530, an error type of the first agent trajectory is retrieved from the database. The database can store agent types and trajectories with corresponding error type labels and a natural language explanation. The error types can include existence constraint, tool misusage, wrong operation target, and value error. The error types can vary based on the domain. For example, for a web domain error, the error types can include wrong operation target, looping without progress, and premature termination.

In block 540, a second agent trajectory is retrieved from the database based on how similar the second agent trajectory is with the first agent trajectory from the AI agent. The second agent trajectory can be part of a set of historical trajectories stored in the database. The second agent trajectory can be the historical trajectory that is most similar to the first agent trajectory.

In block 550, an LLM is prompted to generate an explanation of the second agent trajectory. The LLM may be prompted using an error type and natural language explanation stored in a database that corresponds to the second agent trajectory. The explanation from the LLM can include an error type of the first agent trajectory and a justification. As previously noted, by including the error type and a natural language explanation in the prompt, the accuracy of the LLM increases.

In block 560, the AI agent is prompted to refine accuracy based on the explanation.

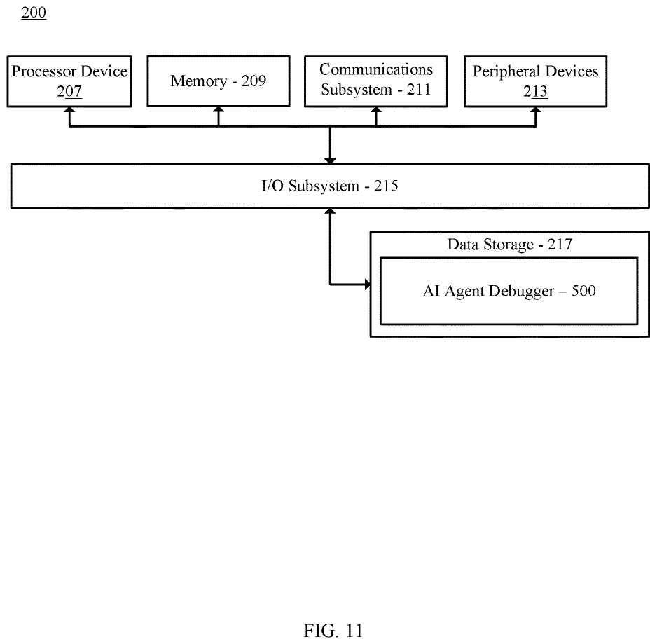

Referring now to FIG. 11, a block diagram of a computer system for video analysis, in accordance with an embodiment of the present invention.

The computing device 200 illustratively includes the processor device 207, the input/output (I/O) subsystem 215, the memory 209, the data storage device 217, and the communications subsystem 211, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 209, or portions thereof, may be incorporated in the processor device 207 in some embodiments.

The processor device 207 may be embodied as any type of processor capable of performing the functions described herein. The processor device 207 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 209 may be embodied as any type of volatile or non-volatile memory or data storage capable of performing the functions described herein. In operation, the memory 209 may store various data and software employed during operation of the computing device 200, such as operating systems, applications, programs, libraries, and drivers. The memory 209 is communicatively coupled to the processor device 207 via the I/O subsystem 215, which may be embodied as circuitry and/or components to facilitate input/output operations with the processor device 207, the memory 209, and other components of the computing device 200. For example, the I/O subsystem 215 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 215 may form a portion of a system-on-a-chip (SOC) and be incorporated, along with the processor device 207, the memory 209, and other components of the computing device 200, on a single integrated circuit chip.

The data storage device 217 may be embodied as any type of device or devices configured for short-term or long-term storage of data such as, for example, memory devices and circuits, memory cards, hard disk drives, solid state drives, or other data storage devices. The data storage device 217 can store program code for debugging artificial intelligence (AI) agents 500. Any or all of these program code blocks may be included in a given computing system.

The communications subsystem 211 of the computing device 200 may be embodied as any network interface controller or other communication circuit, device, or collection thereof, capable of enabling communications between the computing device 200 and other remote devices over a network. The communications subsystem 211 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 213. The peripheral devices 213 may include any number of additional input/output devices, interface devices, and/or other peripheral devices. For example, in some embodiments, the peripheral devices 213 may include a display, touch screen, graphics circuitry, keyboard, mouse, speaker system, microphone, network interface, and/or other input/output devices, interface devices, global positioning system (GPS), camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for debugging artificial intelligence (AI) agents and improving the decision-making of the AI agents comprising:
receiving a first agent trajectory from an AI agent, the first agent trajectory containing at least one failed task;
identifying an error type of the first agent trajectory by referencing historical trajectories stored in a database;
retrieving the error type of the first agent trajectory from the database, wherein the database stores agent types and trajectories with corresponding error type labels and a natural language explanation;
retrieving a second agent trajectory based on similarity from the database;
prompting an LLM to generate an explanation of the second agent trajectory using the corresponding error type and natural language explanation, the explanation of the second agent trajectory including the error type of the first agent trajectory and a justification; and
prompting the AI agent to execute the failed task with an instruction to refine accuracy based on the explanation.

2. The method of claim 1, wherein the error type is retrieved using retrieval augmented generation (RAG).

3. The method of claim 1, wherein the database includes a long-term memory and a short-term memory, and wherein the error types are stored in the long-term memory.

4. The method of claim 1, wherein identifying the error type of the first agent trajectory further includes matching the first agent trajectory with a rule stored in the database.

5. The method of claim 1, wherein the trajectory includes healthcare data and wherein the healthcare data includes sensor data logs.

6. The method of claim 1, wherein the database includes multiple domains and each additional domain increases the accuracy refined by the AI agent.

7. The method of claim 1, wherein the later the failed task appears in the first agent trajectory, the more relevant the failed task becomes.

8. A system, comprising:
a memory device; and
one or more processor devices operatively coupled with the memory device to perform operations, the operations including:
receive a first agent trajectory from an AI agent, the first agent trajectory containing at least one failed task;
identify an error type of the first agent trajectory by referencing historical trajectories stored in a database;
retrieve an error type of the first agent trajectory from the database, wherein the database stores agent types and trajectories with corresponding error type labels and a natural language explanation;
retrieve a second agent trajectory based on similarity from the database;
prompt an LLM to generate an explanation of the second agent trajectory using the corresponding error type and natural language explanation, the explanation of the second agent trajectory including the error type of the first agent trajectory and a justification; and
prompt the AI agent to execute the failed task with an instruction to refine accuracy based on the explanation.

9. The system of claim 8, wherein the error type is retrieved using retrieval augmented generation (RAG).

10. The system of claim 8, wherein the database includes a long-term memory and a short-term memory, and wherein the error types are stored in the long-term memory.

11. The system of claim 8, wherein operation to identify the error type of the first agent trajectory further includes matching the first agent trajectory with a rule stored in the database.

12. The system of claim 8, wherein the trajectory includes healthcare data and wherein the healthcare data includes sensor data logs.

13. The system of claim 8, wherein the database includes multiple domains and each additional domain increases the accuracy refined by the AI agent.

14. The system of claim 8, wherein the later the failed task appears in the first agent trajectory, the more relevant the failed task becomes.

15. A non-transitory computer program product comprising a computer-readable storage medium including a program code, wherein the program code when executed on a computer causes the computer to perform:
receive a first agent trajectory from an AI agent, the first agent trajectory containing at least one failed task;
identify an error type of the first agent trajectory by referencing historical trajectories stored in a database;
retrieve an error type of the first agent trajectory from the database, wherein the database stores agent types and trajectories with corresponding error type labels and a natural language explanation;
retrieve a second agent trajectory based on similarity from the database;
prompt an LLM to generate an explanation of the second agent trajectory using the corresponding error type and natural language explanation, the explanation of the second agent trajectory including the error type of the first agent trajectory and a justification; and
prompt the AI agent to execute the failed task with an instruction to refine accuracy based on the explanation.

16. The non-transitory computer program product of claim 15, wherein the error type is retrieved using retrieval augmented generation (RAG).

17. The non-transitory computer program product of claim 15, wherein the database includes a long-term memory and a short-term memory, and wherein the error types are stored in the long-term memory.

18. The non-transitory computer program product of claim 15, wherein the program code to identify the error type of the first agent trajectory further includes matching the first agent trajectory with a rule stored in the database.

19. The non-transitory computer program product of claim 18, wherein the database includes multiple domains and each additional domain increases the accuracy refined by the AI agent

20. The non-transitory computer program product of claim 15, wherein the trajectory includes healthcare data and wherein the healthcare data includes sensor data logs.
